(19) United States
(12) Patent Application Publication
(10) Pub. No.: US 2022/0232780 A1
(43) Pub. Date: Jul. 28, 2022

(54) PLANT POT DRAINAGE TRAY

(71) Applicants: Jamie Smith, Macomb Twp., MI (US); Jason Van Laere, Macomb Twp., MI (US)

(72) Inventors: Jamie Smith, Macomb Twp., MI (US); Jason Van Laere, Macomb Twp., MI (US)

(21) Appl. No.: 17/560,920

(22) Filed: Dec. 23, 2021

Related U.S. Application Data
(60) Provisional application No. 63/140,535, filed on Jan. 22, 2021.

(51) Int. Cl. A01G 9/04

(52) U.S. Cl. CPC A01G 9/047

(57) ABSTRACT

A drainage tray includes a sloped surface that is sloped in a slope direction from a high point to a low point. A nozzle is arranged at the low point. A plurality of ribs are arranged on the sloped surface. The ribs each include a plurality of alternating first portions that extend in a first direction and second portions that extend in a second direction. The first and second portions are joined by a plurality of bends to define a wavy shape.

### CROSS-REFERENCE TO RELATED APPLICATIONS

This application claims priority to U.S. Provisional Application No. 63/140,535 which was filed on Jan. 22, 2021 and is incorporated herein by reference.

### BACKGROUND

Many known plant pots contain one or more holes in the bottom to drain water away from the plant. Such plant pots are often used with a saucer or tray, which catches any water dripping from the drainage hole in the bottom of the pot. The saucer or tray protects a surrounding surface from water damage from the pot.

Typically, the tray does not include means of removing excess water other than a user removing the tray from under the plant pot and dumping out the water.

Accordingly, it is desirable to provide a drainage tray including an easy means of removing excess water while also providing robust support for plant pots of a variety of sizes.

### BRIEF DESCRIPTION OF THE DRAWINGS

FIG. 1 schematically shows a plant pot with an example drainage tray.

FIG. 2 shows an example drainage tray.

FIG. 3 schematically shows a cross-sectional view of the example drainage tray.

FIG. 4 shows a portion of the example drainage tray.

FIG. 5 shows a bottom view of the example drainage tray.

FIG. 6 shows a detail of the example drainage tray according to an embodiment.

FIG. 7 shows a detail of the example drainage tray according to another embodiment.

### SUMMARY

In one exemplary embodiment, a drainage tray includes a sloped surface that is sloped in a slope direction from a high point to a low point. A nozzle is arranged at the low point. A plurality of ribs are arranged on the sloped surface. The ribs each include a plurality of alternating first portions that extend in a first direction and second portions that extend in a second direction. The first and second portions are joined by a plurality of bends to define a wavy shape.

In another embodiment according to any of the previous embodiments, a side wall extends about a perimeter of the sloped surface.

In another embodiment according to any of the previous embodiments, each of the plurality of ribs are spaced from the side wall such that water can flow between the side wall and the ribs.

In another embodiment according to any of the previous embodiments, the drainage tray is circular and the plurality of ribs are spaced from the side wall at a distance that is less than 10% the diameter of the drainage tray.

In another embodiment according to any of the previous embodiments, the plurality of ribs form a plurality of channels between adjacent ribs. The plurality of channels are oriented along the slope direction.

In another embodiment according to any of the previous embodiments, the plurality of ribs have a first height towards the high point of the sloped surface and a second height towards the low point of the sloped surface. The second height is larger than the first height.

In another embodiment according to any of the previous embodiments, the plurality of channels include alternating narrow gaps and wide gaps.

In another embodiment according to any of the previous embodiments, the drainage tray is circular and the wide gaps define a wide gap distance that is less than 10% the diameter of the drainage tray.

In another embodiment according to any of the previous embodiments, the first direction and the second direction are angled relative to the slope direction.

In another embodiment according to any of the previous embodiments, the first direction is substantially perpendicular to the second direction.

In another embodiment according to any of the previous embodiments, a base is configured to support the drainage tray on a surface. Each of the plurality of ribs has a top edge at a uniform height relative to the base.

In another embodiment according to any of the previous embodiments, base supports extend from the sloped surface in an opposite direction from the plurality of ribs to define the base.

In another embodiment according to any of the previous embodiments, rib circles extend from the sloped surface in an opposite direction from the plurality of ribs. The rib circles are configured to receive support legs.

In another embodiment according to any of the previous embodiments, the nozzle includes one of hose barbs and threads to facilitate attachment of a hose to the nozzle.

In another embodiment according to any of the previous embodiments, each rib includes at least seven bends.

In another exemplary embodiment, a drainage tray includes a sloped surface that is sloped in a slope direction from a high point to a low point. A nozzle is arranged at the low point. A plurality of ribs are arranged on the sloped surface. The plurality of ribs form a plurality of channels between adjacent ribs. The channels are oriented along the slope direction. A side wall extends about the perimeter of the sloped surface. Each of the plurality of ribs are spaced from the side wall such that water can flow between the side wall and the ribs.

In another embodiment according to any of the previous embodiments, a base is configured to support the drainage tray on a surface. Each of the plurality of ribs has a top edge at a uniform height relative to the base.

In another embodiment according to any of the previous embodiments, the drainage tray is circular and the widest distance between adjacent ribs is less than 10% the diameter of the drainage tray.

In another embodiment according to any of the previous embodiments, the drainage tray is circular. The plurality of ribs are spaced from the side wall at a distance that is less than 10% the diameter of the drainage tray.

In another embodiment according to any of the previous embodiments, there are at least ten ribs.

### DETAILED DESCRIPTION

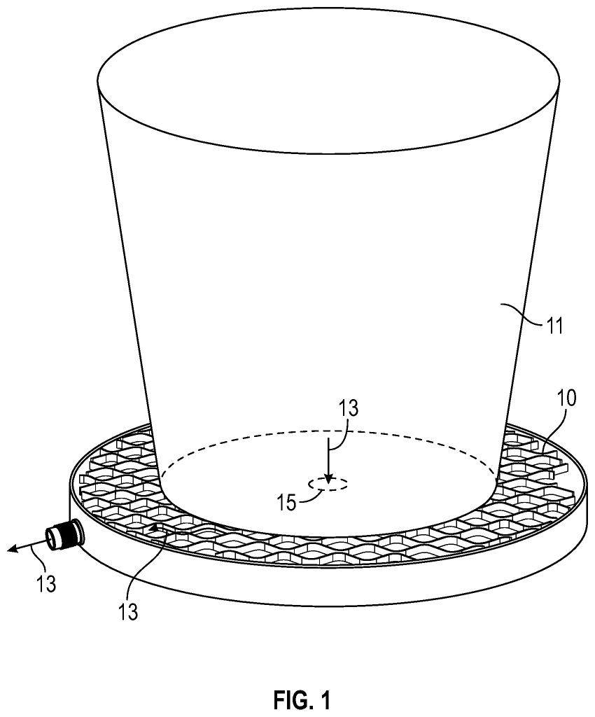

FIG. 1 schematically illustrates a plant pot 11 placed on an example drainage tray 10. The drainage tray 10 is arranged beneath the plant pot 11, and catches water 13 that drips from a drainage hole 15 at the bottom of the pot 11. The drainage tray 10 may also catch water overflowing from a top of the pot 11, in some examples.

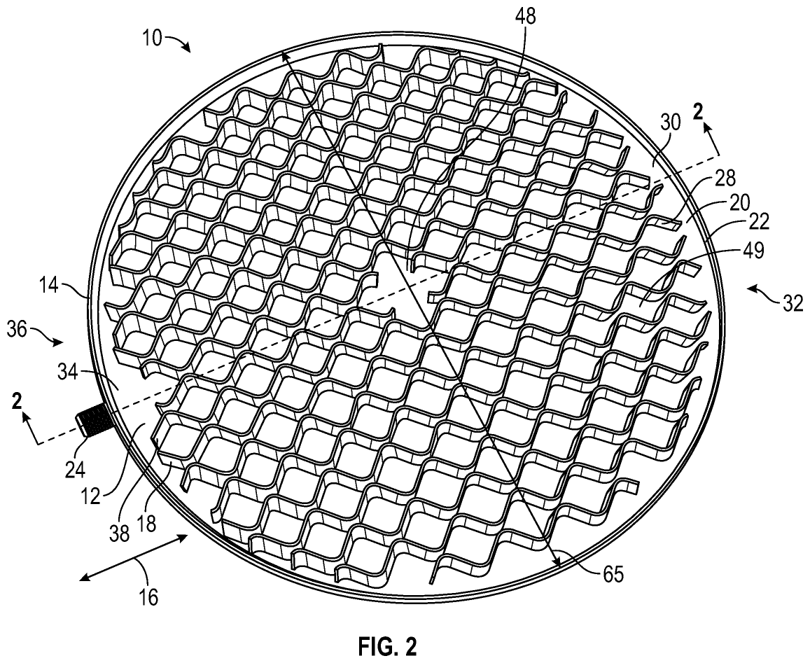

FIG. 2 illustrates the example drainage tray 10 for use with a plant pot. The drainage tray 10 generally includes a sloped surface 12 surrounded by a side wall 14 extending around a perimeter 22 of the drainage tray 10. In this example, the tray 10 is circular. The sloped surface 12 slopes in a slope direction 16 from a high point 30 at a first side 32 to a low point 34 at a second side 36. A sprout or nozzle 24 is arranged in the side wall 14 at the low point 34 of the sloped surface 12, such that water can flow down the sloped surface 12 to the spout 24. A plurality of ribs 18 are arranged on the sloped surface 12, and are generally oriented along the slope direction 16. In one example, there are at least ten ribs 18, or about twenty ribs 18. The plurality of ribs 18 are spaced from the side wall 14 to form a gap 20 about the perimeter 22. The plurality of ribs 18 are arranged such that water flows between the ribs 18 and along the gap 20 towards the nozzle 24.

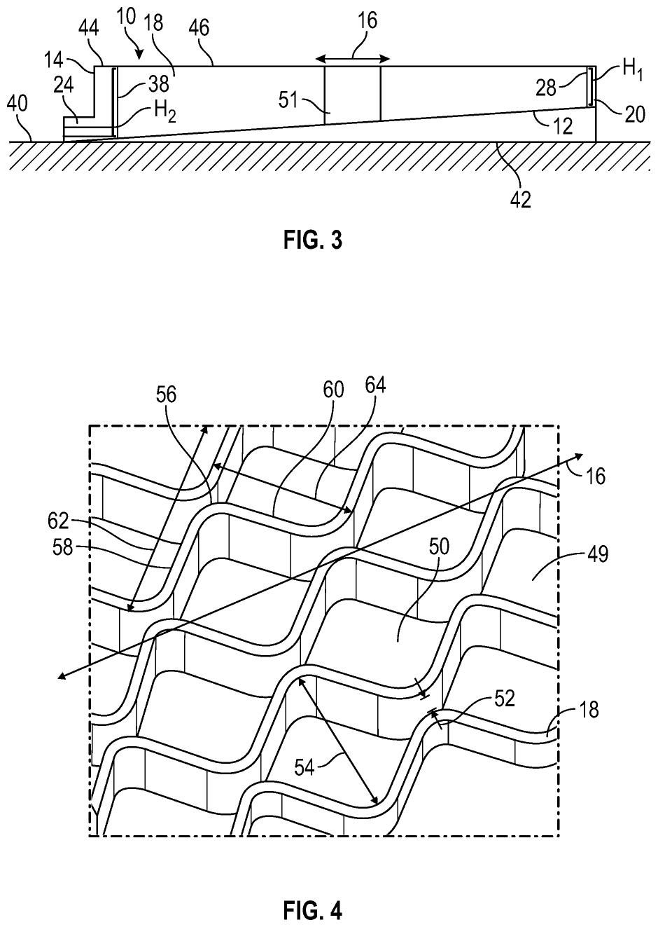

FIG. 3 illustrates a cross sectional view along the line 2-2 in FIG. 1. In this example, the tray 10 is sitting on a substantially horizontal surface 40. The surface 40 may be the ground, a deck, a table, or plant stand, for example. The base 42 of the tray 10 rests on the surface 40. A top edge 44 of the side wall 14 extends substantially parallel to the horizontal surface 40. As shown in this view, the sloped surface 12 is sloped relative to the base 42 and the top edge 44 of the side wall 14.

Each of the ribs 18 extends in a vertical direction between the sloped surface 12 and a top edge 46, and in a horizontal direction from an upstream end 28 to a downstream end 38. In the illustrated example, a few of the ribs 18 have a break 51 near a center 48 (shown in FIG. 1) of the sloped surface 12. The upstream end 28 of the rib 18 has a first height H₁ between the sloped surface 12 and the top edge 46 and the downstream end 38 has a second height H₂ between the sloped surface 12 and the top edge 46. The second height H₂ is larger than the first height H₁. In the illustrated example, the top edge 46 of the ribs 18 is level with the top edge 44 of the side wall 14. In other embodiments, the top edge 44 of the side wall 14 may extend beyond the top edge 46 of the ribs 18. The top edges 46 of the plurality of ribs 18 extend substantially parallel to the horizontal surface 40 and provide support for a plant pot during use. In other words, the top edges 46 of the plurality of ribs 18 are spaced at a uniform height relative to the base 42 of the tray 10.

FIG. 4 illustrates a portion of the drainage tray 10. The ribs 18 extend along the slope direction 16. Each of the ribs 18 is wavy, and is offset from an adjacent rib. In this way, each rib 18 forms a channel 49 with an adjacent rib 18 defined by a plurality of pockets 50. The pockets 50 formed between two adjacent ribs 18 are interconnected along the slope direction 16. In other words, the ribs 18 form channels 49 with alternating narrow gaps 52 and wide gaps 54. The wide gaps 54 are the widest portion of the pocket 50. The widest distance between ribs 18 is substantially perpendicular to the slope direction 16. The wavy ribs 18 are arranged to permit water caught from the plant pot to flow down the sloped surface 12 between the ribs 18 toward the nozzle 24.

The gap 20 provided between the plurality of ribs 18 and the side wall 14 facilitates better water flow to the nozzle 24. The gap 20 both acts a path for water to travel down the sloped surface 12 to the nozzle 24 and serves as a manifold to distribute water to the channels 49 formed by the ribs 18.

In the illustrated embodiment, the wavy shape of each of the ribs 18 is formed from plurality of first portions 58 that extend in a first direction 62 and a plurality of second portions 60 that extend in a second direction 64. The first portions 58 and second portions 60 alternate along the length of each rib 18 and are joined by a plurality of bends 56 that form the wavy shape. The first direction 62 and the second direction 64 are angled relative to the slope direction 16. In one example, the first direction 62 is substantially perpendicular to the second direction 64. In one example, each rib 18 has at least seven bends 56.

The top edges 46 of the ribs 18 provide support for a plant pot during use. The wavy arrangement of the ribs 18 provides support for a variety of different plant pot sizes. The wavy arrangement also provides a more stable support at the top edges 46 of the ribs 18 compared to an arrangement of parallel linear ribs. The tray 10 may have a diameter 65 of about 19 inches or about 25 inches, for example. Of course, other sizes may be used. The wavy ribs 18 may provide support for one large pot, or a plurality of much smaller pots. The largest gap between any two ribs 18 or the side wall 14 (i.e. gap 20) is the wide gap distance 54. In one example, the wide gap distance 54 is less than 10% the diameter 65 of the tray 10. More narrowly, the wide gap distance 54 is between 5% and 10% the diameter 65 of the tray 10, or more narrowly between 6% and 8% the diameter 65. Of course, other gap distances 54 may be used.

In one example, the ribs 18 are arranged to support a plant pot having a diameter about the same as the wide gap 54, or smaller. Small plant pots may be arranged anywhere on the tray 10, as the ribs 18 are spread over the entire sloped surface 12. Accordingly, the wavy arrangement of the ribs 18 facilitates the drainage tray 10 being relatively compact by providing a support surface over a majority of the footprint of the drainage tray 10.

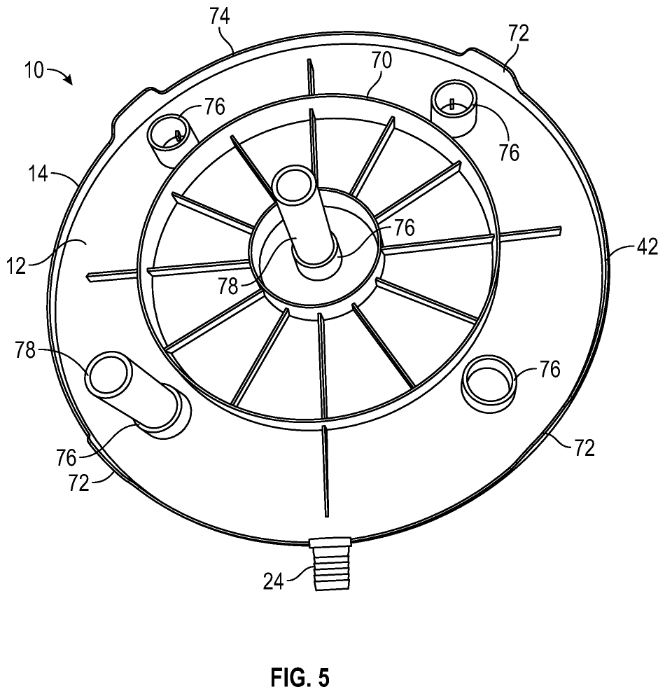

FIG. 5 illustrates a bottom view of the example drainage tray 10. The tray 10 may have an arrangement of base support 70 extending from the sloped surface 12 in an opposite direction from the ribs 18 to form the base 42. The base support 70 provide support for the tray 10 to sit on a horizontal surface 40 (shown in FIG. 2). In one example, the side wall 14 has a plurality of feet 72 that extend downward to support the tray 10, leaving a plurality of gaps 74 between the side wall 14 and the horizontal surface 40.

The tray 10 may further include rib circles 76 extending from the sloped surface 12 in an opposite direction from the ribs 18. The rib circles 76 are hollow cylinders configured to receive support legs 78. In one example, the support legs are 1 inch diameter PVC piping. Of course, other materials and diameters may be used for support legs 78. The rib circles 76 allow a user to easily insert support legs 78 of different lengths to adjust the tray 10 to a desired height. In one example there are five rib circles 76, with one central rib circle 76 and one rib circle 76 in each quadrant of the tray 10.

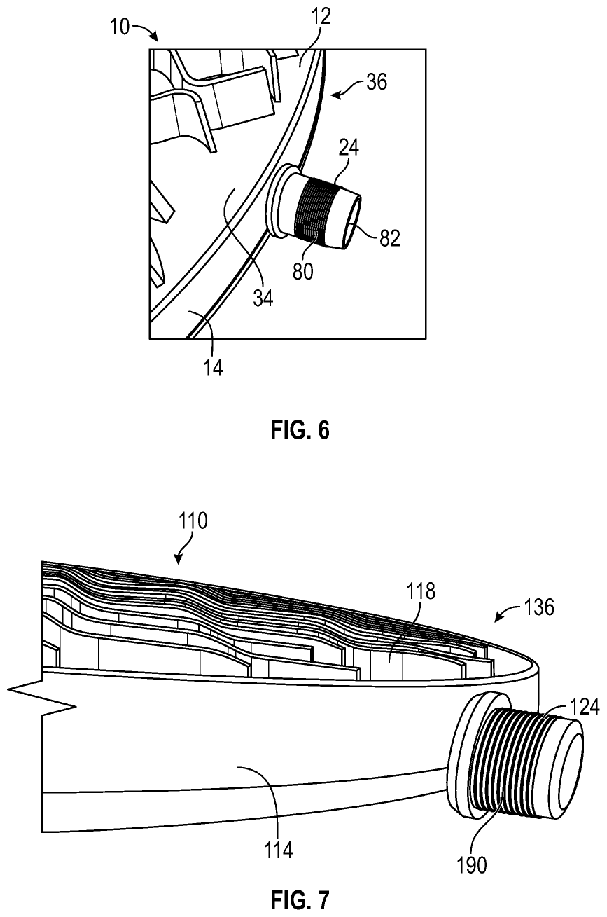

FIG. 6 illustrates the nozzle 24 of the example tray 10. The nozzle 24 is arranged in the side wall 14 at the second side 36 near the low point 34 of the sloped surface 12. The nozzle 24 may be substantially cylindrical. Water that flows along the sloped surface 12 exits the tray 10 by flowing out the nozzle 24. This prevents excess water from accumulating in the tray 10 and overflowing over the side walls 14 or rising to the level of a plant pot's drainage hole 15 resting on the top edges 46, which can be unhealthy for a plant's roots.

In some examples, the nozzle 24 may have a plurality of hose barbs 80 for attachment of a hose or tube. In some examples, the nozzle 24 may also have internal threads 82 at an inner diameter. In this way, the nozzle 24 can be connected to a hose or tube via a male or female connection.

FIG. 7 illustrates another example nozzle 124 for an example drainage tray 110. To the extent not otherwise described or shown, the tray 110 corresponds to the tray 10 of FIG. 2, with like parts having reference numerals preappended with a “1.” In this example, the nozzle 124 has threads 190. The threads 190 may permit attachment of a hose, for example.

It should be understood that the present description is not limiting and should not be taken to represent all embodiments of the device according to this disclosure. Additionally, certain other combinations or features which may become apparent to those skilled in the art should be considered as within the scope of this disclosure.

1. A drainage tray, comprising:
a sloped surface that is sloped in a slope direction from a high point to a low point;
a nozzle arranged at the low point; and
a plurality of ribs arranged on the sloped surface, the ribs each including a plurality of alternating first portions that extend in a first direction and second portions that extend in a second direction, the first and second portions joined by a plurality of bends to define a wavy shape.

2. The drainage tray as recited in claim 1, further comprising a side wall that extends about a perimeter of the sloped surface.

3. The drainage tray as recited in claim 2, wherein each of the plurality of ribs are spaced from the side wall such that water can flow between the side wall and the ribs.

4. The drainage tray as recited in claim 3, wherein the drainage tray is circular and the plurality of ribs are spaced from the side wall at a distance that is less than 10% the diameter of the drainage tray.

5. The drainage tray as recited in claim 1, wherein the plurality of ribs form a plurality of channels between adjacent ribs, the plurality of channels oriented along the slope direction.

6. The drainage tray as recited in claim 5, wherein the plurality of ribs have a first height towards the high point of the sloped surface and a second height towards the low point of the sloped surface, the second height larger than the first height.

7. The drainage tray as recited in claim 5, wherein the plurality of channels include alternating narrow gaps and wide gaps.

8. The drainage tray as recited in claim 7, wherein the drainage tray is circular and the wide gaps define a wide gap distance that is less than 10% the diameter of the drainage tray.

9. The drainage tray as recited in claim 1, wherein the first direction and the second direction are angled relative to the slope direction.

10. The drainage tray as recited in claim 9, wherein the first direction is substantially perpendicular to the second direction.

11. The drainage tray as recited in claim 1, further comprising a base configured to support the drainage tray on a surface, and wherein each of the plurality of ribs has a top edge at a uniform height relative to the base.

12. The drainage tray as recited in claim 11, further comprising base supports extending from the sloped surface in an opposite direction from the plurality of ribs to define the base.

13. The drainage tray as recited in claim 11, further comprising rib circles extending from the sloped surface in an opposite direction from the plurality of ribs, the rib circles configured to receive support legs.

14. The drainage tray as recited in claim 1, wherein the nozzle includes one of hose barbs and threads to facilitate attachment of a hose to the nozzle.

15. The drainage tray as recited in claim 1, wherein each rib includes at least seven bends.

16. A drainage tray, comprising:
a sloped surface that is sloped in a slope direction from a high point to a low point;
a nozzle arranged at the low point;
a plurality of ribs arranged on the sloped surface, the plurality of ribs forming a plurality of channels between adjacent ribs, the channels oriented along the slope direction; and
a side wall that extends about the perimeter of the sloped surface, each of the plurality of ribs spaced from the side wall such that water can flow between the side wall and the ribs.

17. The drainage tray as recited in claim 16, further comprising a base configured to support the drainage tray on a surface, and wherein each of the plurality of ribs has a top edge at a uniform height relative to the base.

18. The drainage tray as recited in claim 16, wherein the drainage tray is circular and the widest distance between adjacent ribs is less than 10% the diameter of the drainage tray.

19. The drainage tray as recited in claim 16, wherein the drainage tray is circular and the plurality of ribs are spaced from the side wall at a distance that is less than 10% the diameter of the drainage tray.

20. The drainage tray as recited in claim 16, wherein there are at least ten ribs.
